(19) United States
(12) Patent Application Publication
(10) Pub. No.: US 2007/0226638 A1
(43) Pub. Date: Sep. 27, 2007

(54) Selecting a stored content item for use in a task

(75) Inventors: Steffen Kramer, Frederiksberg (DK); Lars Markussen, Frederiksberg (DK); Peter Wass-Danielsen, Hellerup (DK); Tita Kangas, Kaarina (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/388,835

(22) Filed: Mar. 23, 2006

(51) Int. Cl. G06F 9/00

(52) U.S. Cl. 715/764; 715/810; 715/853; 715/968

(57) ABSTRACT

A user interface, a device, a computer program and a method for using a stored content item in a task including: first means for presenting a first user selectable option for using a stored content item in a first task; second means, responsive to the first means, for presenting simultaneously a second user selectable option, the selection of which presents a first interface for finding a content item for use in the first task, and a third, different, user selectable option, the selection of which presents a second interface for finding a content item for use in the first task.

### FIELD OF THE INVENTION

Embodiments of the present invention relate to a user interface, a device, a computer program and a method for selecting a stored content item for use in a task.

### BACKGROUND TO THE INVENTION

Content items stored in an electronic device may originate from different sources. They may, for example, be preinstalled, downloaded, user created, received etc. The electronic device may automatically store some content in predetermined locations which may vary from device to device. In addition, a user may choose to store data items in their own chosen locations and the strategy used for choosing suitable storage locations may change over time or may not be easily recalled by a user. These problems are exacerbated as the amount of content increases and as the sources of different content increases.

The value that a user attaches to the electronic device may decrease if it is or becomes difficult to access content items using it. Likewise the value a user attaches to an electronic device increases or remains high if it is or remains effective at accessing stored content items.

It would therefore be desirable to improve how a user can access stored content items using an electronic device.

### BRIEF DESCRIPTION OF THE INVENTION

According to one embodiment of the invention there is provided a user interface for using a stored content item in a task comprising: first means for presenting a first user selectable option for using a stored content item in a first task; and second means, responsive to the first means, for presenting simultaneously a second user selectable option, the selection of which presents a first interface for finding a content item for use in the first task, and a third, different, user selectable option, the selection of which presents a second interface for finding a content item for use in the first task.

This provides the advantage that the user can access stored data items in more than one way. The user is presented with multiple options so that they can select their preferred way of accessing a data item at the time of selection.

The first interface may be a first user navigation interface for enabling the user to find a content item for use in the first task by navigating a plurality of a content items and the second interface may be a second user navigation interface for enabling the user to find a content item for use in the first task by navigating a plurality of content items. The first interface may present a navigable list of content items. The navigable list of content items may be generated by scanning one or more memories. The second interface may present a root level of a predetermined hierarchical directory structure having a plurality of navigable levels.

According to another embodiment of the invention there is provided an electronic device comprising: a user input device for enabling user selection; a display for presenting information, including options, to a user; a processor operable to read from a memory, to control the display and to receive inputs from the user input device, wherein the processor is operable to control the display to present a first user selectable option for using a stored content item in a first task and is responsive to selection of the first option to present simultaneously a second user selectable option, the selection of which presents a first interface for finding a content item for use in the first task, and a third, different, user selectable option, the selection of which presents a second interface for finding a content item for use in the first task.

According to another embodiment of the invention there is provided a method of controlling the selection of a stored content item for use in a task comprising: presenting a first user selectable option for using a stored content item in a first task; and in response to user selection of the first option, presenting simultaneously a second user selectable option, the selection of which presents a first interface for finding a content item for use in the first task, and a third, different, user selectable option, the selection of which presents a second interface for finding a content item for use in the first task.

According to another embodiment of the invention there is provided a physical entity embodying a computer program for controlling the selection of a stored content item for use in a task comprising computer program instructions that: present in a display a first user selectable option for using a stored content item in a first task; and respond to user selection of the first option, to present simultaneously in the display a second user selectable option, the selection of which presents a first interface for finding a content item for use in the first task, and a third different, user selectable option, the selection of which presents a second interface for finding a content item for use in the first task.

### BRIEF DESCRIPTION OF THE DRAWINGS

For a better understanding of the present invention reference will now be made by way of example only to the accompanying drawings in which:

FIG. 1 schematically illustrates an electronics device;

FIG. 2 is a schematic illustration of the functions performed by the device; and

FIG. 3 illustrates the states of the device's user interface.

### DETAILED DESCRIPTION OF EMBODIMENTS OF THE INVENTION

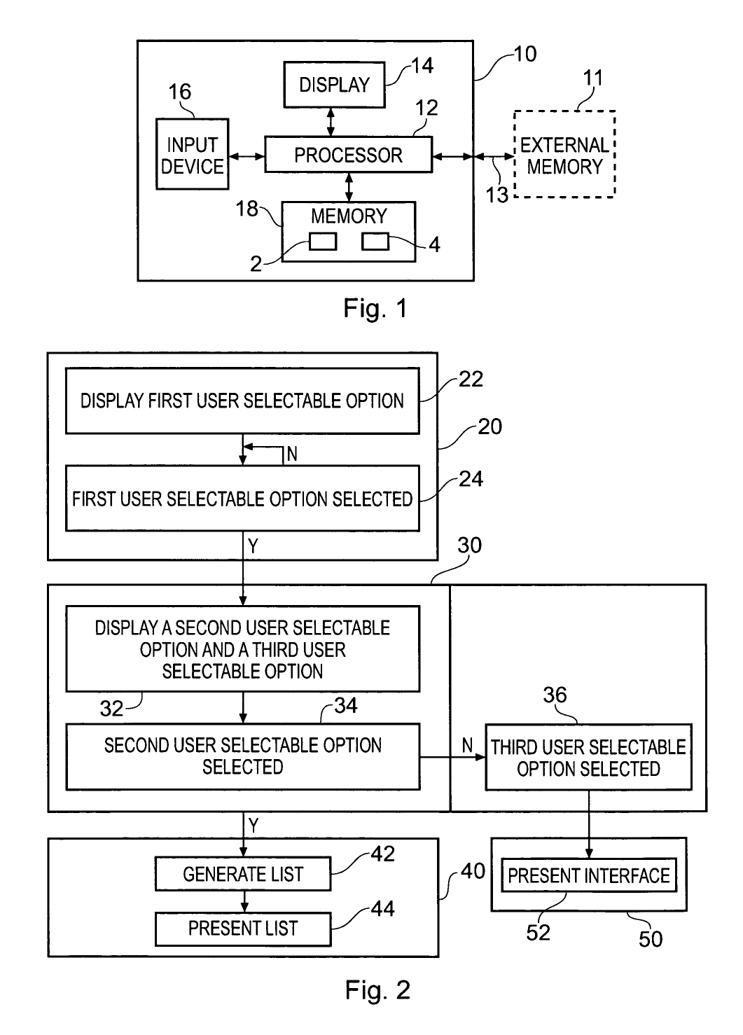

FIG. 1 schematically illustrates an electronics device 10 comprising: a processor 12, a display 14, an input device 16 and a memory 18.

Only as many components are illustrated as are necessary to describe the following implementation of the invention. It should be appreciated that additional and/or alternative components may be used in other implementations. For example although only a single internal memory is illustrated, the device may have additional internal or external memories 11 and/or interfaces 13 for connecting with such memories. An external memory 11 may be, for example, a memory card, a hard disk etc.

The electronic device 10 may be any electronic device that is used to access stored content items 4. It may be a personal computer, a personal digital assistant, a camera, a mobile cellular telephone, a media player etc. The novel user interface 60 used to access stored content items 4 is particularly useful in devices with limited display sizes such as hand-portable electronic devices.

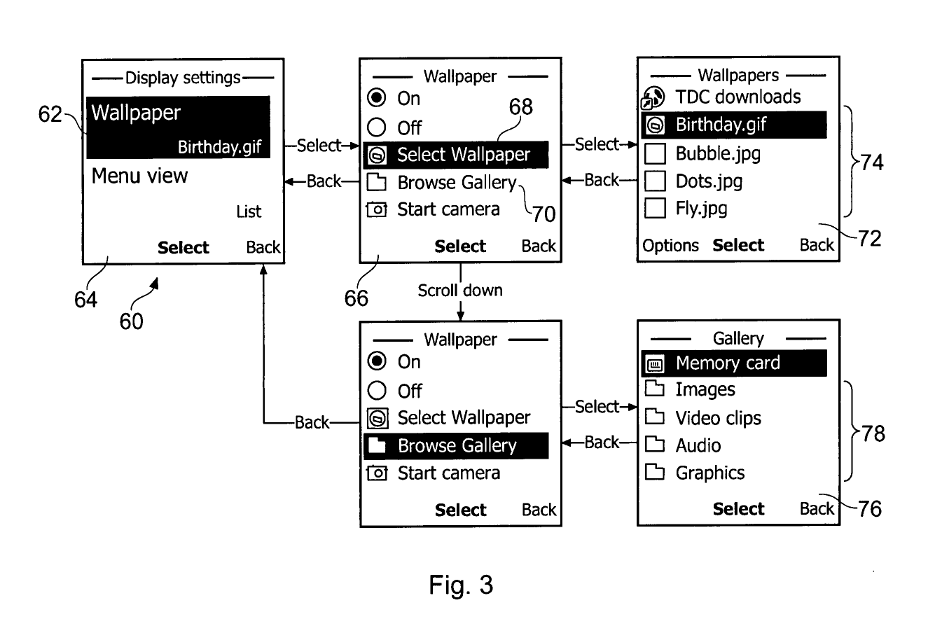

The processor 12 is connected to read from and write to the memory 18. The memory 16 stores computer program instructions 2, which when loaded into the processor 12 control its operation. The computer program instructions 2 provide the logic and routines that enable the electronic device to perform the methods illustrated in FIGS. 2 and 3.

The computer program instructions may arrive at the electronic device 10 via an electromagnetic carrier signal or be copied from a physical entity such as a computer program product, a memory device or a record medium such as a CD-ROM or DVD.

The memory 18 also stores content items 4. If additional memories are present in the device 10 or are connected to the device 10, the content items may be distributed throughout the available memories. The content items may be any form of digital content. Typically they are media content items such as image, music, ring tone, or video files but they may also be text documents. The content items may be personalized in some manner. They may be preinstalled, downloaded, received, user created etc.

The processor 12 receives user input commands from the user input device 16. The user input device 16 may be any suitable input device that allows a user to move a highlight or cursor and to perform a selection function. If the electronic device 10 is a mobile cellular telephone, the user input device may be, for example, a 5-way joystick or it may be a collection of keys including a scroll-up key, a scroll-down key and a selection key.

The processor 12 is connected to provide control signals that control the user interface 60 presented by the display 14.

FIG. 2 is a schematic illustration of the functions performed by the processor 12 when controlling the user interface 60. FIG. 3 illustrates the corresponding states of the user interface 60.

A first module 20 may be activated in any suitable manner. One option is for the first module 20 to be activated by the user in response to starting an application or in response to the selection of a menu option.

The first module 20, at step 22, presents a first user selectable option 62 in a ‘page’ of the user interface 60. The first option 62 is for using a stored content item 4 during a task. The first option may be one of multiple options, where each option relates to a different content type such as picture, video, music. In the example of FIG. 3, the task is a ‘picture’ task and involves choosing a wallpaper or background used by the display 14 as a backdrop to displayed menu items. In another example, a ‘picture’ task may be inserting an image when composing a document or message, such as a multimedia messaging service (MMS) message for transmission, for example, in a cellular telecommunications network. In further example, a ‘music’ task may be inserting an music file when composing a message, such as a multimedia messaging service (MMS) message for transmission, for example, in a cellular telecommunications network.

The selection of the first user selectable option 62 activates, at step 24, a second module 30.

The second module 30, at step 32, presents simultaneously, in a ‘page’ 66 of the user interface 60, a second user selectable option 68 and a third, different, user selectable option 70. The page 66 also presents a user selectable option for creating content, in this example ‘start camera’, The different options are selected by moving the highlight using scroll keys and performing a selection using a soft (programmable) key at the base of the display.

The selection of the second user selectable option 68 activates, at step 34, a third module 40. The selection of the third user selectable option 70 activates, at step 36, a fourth module 50.

The third module 40 generates, at step 42, a list of content items. The list generated depends upon context, in the sense that it depends upon the current task and also upon the storage devices attached to the device (if any). The list 74 includes data items that are accessible by the device 10 and are suitable for the current task. The processor 12 first identifies the available storage devices and memories and then scans the memory 16 and any other accessible memories whether internal or external to find, in this example, image files. In the illustrated example, files with an extension ‘jpg’ or ‘gif’ are found.

The third module 40 then presents, at step 44, a first user navigation interface 72 for finding a content item 4 for use in the first task by navigating a list 74 of content items 4. Icons for the files found in step 42 are displayed as a list 74 in the interface 72 and selection of an icon selects the image file associated with that icon. The list of items may be searched by file name text.

The list illustrated is a one dimensional, non-hierarchical list that is navigable using a scroll key. An icon can be selected by scrolling a highlight up/down and performing a selection.

The fourth module 50 presents a second user navigation interface 76 for finding a content item 4 for use in the first task by navigating a plurality of content items 4. The second interface 76 presents a root (initial, highest) level of a predetermined hierarchical directory structure having a plurality of navigable levels.

The hierarchical directory structure is organized as a tree with ‘leaf’ nodes and ‘branch’ nodes. A leaf node is connected to a branch node in the next highest level and is not connected to anything at a lower level. A leaf node represents a data item. A branch node is connected to a single branch node in the next highest level and to one or more leaf/branch nodes in the next lowest level. The branch nodes consequently represent ‘folders’ comprising other folders and/or data items. The directory is navigated by returning to the next highest branch node or continuing to one of the branch/leaf nodes at the next lowest level. When the user has navigated to a particular node at a particular level, the interface 76 displays an icon for each of the branch/leaf nodes connected to it in the next lowest level. In the particular example illustrated, the icons are displayed as a list so that they may be navigated using a scroll key but other arrangements are possible. An icon can be selected by scrolling a highlight up/down and performing a selection.

Although embodiments of the present invention have been described in the preceding paragraphs with reference to various examples, it should be appreciated that modifications to the examples given can be made without departing from the scope of the invention as claimed. For example, in an alternative embodiment, an option for selecting a text search interface is provided in addition to or as an alternative to the options displayed at page 66 of the user interface 60. A text search interface enables a user to find a content item 4 for use in the first task by performing a search for a text string.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A user interface for using a stored content item in a task comprising:
first means for presenting a first user selectable option for using a stored content item in a first task; and
second means, responsive to the first means, for presenting simultaneously a second user selectable option, the selection of which presents a first interface for finding a content item for use in the first task, and a third, different, user selectable option, the selection of which presents a second interface for finding a content item for use in the first task.

2. A user interface as claimed in claim 1, wherein the first interface is a first user navigation interface for enabling the user to find a content item for use in the first task by navigating a plurality of a content items and the second interface is a second user navigation interface for enabling the user to find a content item for use in the first task by navigating a plurality of content items.

3. A user interface as claimed in claim 2, wherein the first interface presents a navigable list of content items.

4. A user interface as claimed in claim 3, wherein the navigable list of content items is generated by scanning one or more memories.

5. A user interface as claimed in claim 3, wherein the navigable list of content items is context dependent.

6. A user interface as claimed in claim 2, wherein the second interface presents a root level of a predetermined hierarchical directory structure having a plurality of navigable levels.

7. A user interface as claimed in claim 6, wherein the each level is presented as a list.

8. A user interface as claimed in claim 1 wherein the first task is setting a wallpaper.

9. A user interface as claimed in claim 1 wherein the first task is inserting an image when composing a message.

10. A user interface as claimed in claim 1, wherein the first interface is a user navigation interface, for enabling the user to find a content item for use in the first task by navigating a plurality of a content items and the second interface is a text search interface for enabling the user to find a content item for use in the first task by performing a search for a text string.

11. An electronic device comprising:
a user input device for enabling user selection;
a display for presenting information, including options, to a user;
a processor operable to read from a memory, to control the display and to receive inputs from the user input device, wherein the processor is operable to control the display to present a first user selectable option for using a stored content item in a first task and is responsive to selection of the first option to present simultaneously a second user selectable option, the selection of which presents a first interface for finding a content item for use in the first task, and a third, different, user selectable option, the selection of which presents a second interface for finding a content item for use in the first task.

12. A device as claimed in claim 11, wherein the first interface is a first user navigation interface for enabling the user to find a content item for use in the first task by navigating a plurality of a content items and the second interface is a second user navigation interface for enabling the user to find a content item for use in the first task by navigating a plurality of a content items.

13. A device as claimed in claim 12, wherein the first interface presents a navigable list of content items.

14. A device as claimed in claim 13, wherein the navigable list of content items is generated by scanning one or more memories.

15. A device as claimed in claim 13, wherein the navigable list of content items is context dependent.

16. A device as claimed in claim 12 wherein the second interface presents a root level of a predetermined hierarchical directory structure having a plurality of navigable levels.

17. A device as claimed in claim 16, wherein each level is presented as a list.

18. A method of controlling the selection of a stored content item for use in a task comprising:
presenting a first user selectable option for using a stored content item in a first task; and
in response to user selection of the first option, presenting simultaneously a second user selectable option, the selection of which presents a first interface for finding a content item for use in the first task, and a third, different, user selectable option, the selection of which presents a second interface for finding a content item for use in the first task.

19. A physical entity embodying a computer program for controlling the selection of a stored content item for use in a task comprising computer program instructions that:
present in a display a first user selectable option for using a stored content item in a first task; and
respond to user selection of the first option, to present simultaneously in the display a second user selectable option, the selection of which presents a first interface for finding a content item for use in the first task, and a third, different, user selectable option, the selection of which presents a second interface for finding a content item for use in the first task.
